(19) United States
(12) Patent Application Publication
(10) Pub. No.: US 2015/0100867 A1
(43) Pub. Date: Apr. 9, 2015

(54) METHOD AND APPARATUS FOR SHARING AND DISPLAYING WRITING INFORMATION

(71) Applicant: SAMSUNG ELECTRONICS CO., LTD., Suwon-si (KR)

(72) Inventors: Yu-sung JOO, Yongin-si (KR); Sung-kee KIM, Hwaseong-si (KR); Jae-jun LEE, Suwon-si (KR); Dae-hyung KWON, Seoul (KR); Sung-uk RYU, Daegu (KR); Hyun-woo LIM, Seoul (KR); Do-young JOUNG, Seoul (KR)

(73) Assignee: SAMSUNG ELECTRONICS CO., LTD., Suwon-si (KR)

(21) Appl. No.: 14/507,159

(22) Filed: Oct. 6, 2014

(30) Foreign Application Priority Data
Oct. 4, 2013 (KR) 10-2013-0118730
Nov. 29, 2013 (KR) 10-2013-0147817

(51) Int. Cl. G06F 17/24; G09G 5/12; G09G 5/377; G06F 17/21

(52) U.S. Cl. CPC G06F 17/241; G06F 17/212; G09G 5/12; G09G 5/377; G09G 2354/00; G09G 2340/12; G09G 2340/125
USPC 715/203

(57) ABSTRACT

Apparatuses and methods for sharing writing information are provided. In one example, the method includes receiving a request to display content from a user, obtaining writing information about the content and content synchronization information that is used to synchronize a location of the writing information with respect to the content, and synchronizing and displaying the writing information and the content based on the content synchronization information.

### CROSS-REFERENCE TO RELATED APPLICATIONS

This application claims priority from Korean Patent Application No. 10-2013-0118730, filed on Oct. 4, 2013, and Korean Patent Application No. 10-2013-0147817, filed on Nov. 29, 2013, in the Korean Intellectual Property Office, the entire disclosures of which are incorporated herein by reference.

### BACKGROUND

1. Field

Apparatuses and methods consistent with exemplary embodiments relate to a method of sharing and displaying writing information, and more particularly, to a method of storing and sharing writing information about content displayed on a screen, and a method of displaying the writing information.

2. Description of Related Art

Generally, a user writes information about content using a writing instrument such as a pen or pencil on paper included in, for example, a book or a notebook, and the like. Recently, multimedia technologies and mobile display apparatuses have been developed which allow direct input of writing information by a user about content to a screen of a device.

Generally, because the writing information input to a device by a user is encoded with content, it is difficult to individually share the writing information or control a display of the writing information. For example, because it is illegal to modify copyright-related content, a user is not able to store the copyright-related content together with writing information about the copyright-related content. Accordingly, the user must separately store the writing information.

Even when the user separately stores writing information, it is difficult for the user to distinguish which content the writing information corresponds to. Therefore, in order for the user to use the writing information using a different device than the device that received the writing information, the user has to directly store and manage the content and the writing information.

Furthermore, while displaying writing information on a device, the displayed writing information does not change according to content that is displayed on the device. Accordingly, a user has to directly delete or modify the writing information.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments include a method of sharing writing information with another device, and a method of displaying writing information on a screen of a device or other apparatus.

Additional aspects will be set forth in part in the description which follows and, in part, will be apparent from the description, or may be learned by practice of the exemplary embodiments.

According to an aspect of an exemplary embodiment, there is provided a method of sharing writing information, the method including receiving a request to display content from a user; obtaining the content, writing information about the content, and content synchronization information required to synchronize the content and the writing information; and synchronizing and displaying the writing information and the content based on the content synchronization information.

The method may further include determining that the writing information about the content and the content synchronization information are present.

The obtaining may include obtaining the content synchronization information; and obtaining at least one of the writing information and the content based on the obtained content synchronization information.

The obtaining may include obtaining the content; and obtaining at least one of the writing information and the content synchronization information based on the obtained content.

The content synchronization information may include at least one of identification (ID) information of the content and location information of the writing information.

The location information of the writing information may include at least one of page information of the content, frame information of the content, a location of the writing information with respect to a page of the content, and a location of the writing information with respect to a frame of the content.

The writing information may include at least one of event information about a writing start event and a writing finish event, and text information about the writing information.

The content may include video content, and the synchronizing and displaying of the writing information and the content based on the content synchronization information may include extracting and displaying writing information corresponding to at least one frame of the video content.

The content may include document content, and the synchronizing and displaying of the writing information and the content based on the content synchronization information may include extracting and displaying writing information corresponding to at least one page of the document content.

The obtaining may include obtaining connection address information about at least one of the writing information, the content synchronization information, and the content; and obtaining at least one of the writing information, the content synchronization information, and the content, from an external device, based on the obtained connection address information.

According to an aspect of another exemplary embodiment, provided is a computer-readable recording medium that has recorded thereon a program for executing the method.

According to an aspect of another exemplary embodiment, there is provided a method of sharing writing information, the method including displaying content; obtaining writing information based on a user input with respect to the displayed content; and transmitting the writing information and content synchronization information including identification (ID) information of the content and location information of the writing information with respect to the content, to an external device.

The content synchronization information may be information used by the external device to synchronize the writing information and the content.

The method may further include storing the content synchronization information and the writing information; and synchronizing and displaying the stored writing information and the content based on the stored content synchronization information.

The obtaining of the writing information may include detecting a writing start event and a writing finish event; and generating the writing information based on the detected writing start event and the detected writing finish event.

The transmitting may include generating connection address information about at least one of the content, content information, and the writing information; and transmitting the generated connection address information to the external device.

The location information of the writing information may include at least one of frame information of the content, page information of the content, coordinate information of the writing information with respect to a page of the content, and coordinate information of the writing information with respect to a frame of the content.

According to an aspect of another exemplary embodiment, there is provided a device for sharing writing information, the device including a display request receiver that receives a request to display content from a user; an information obtainer that obtains the content, writing information about the content, and content synchronization information; and a display unit that synchronizes and displays the writing information and the content based on the content synchronization information.

The device may further include an information determiner that determines the writing information about the content and the content synchronization information are present.

The device may further include an information obtainer that obtains at least one of the writing information, the content, and the content synchronization information.

The information obtainer may obtain the content synchronization information and obtain at least one of the writing information and the content based on the obtained content synchronization information.

The information obtainer may obtain the content and obtain at least one of the writing information and the content synchronization information based on the obtained content.

The content synchronization information may include at least one of identification (ID) information of the content and location information of the writing information.

The location information of the writing information may include at least one of page information of the content, frame information of the content, a location of the writing information with respect to a page of the content, and a location of the writing information with respect to a frame of the content.

The writing information may include at least one of event information about a writing start event and a writing finish event, and text information about the writing information.

The content may include video content, and the display unit may extract and display the writing information corresponding to at least one frame of the video content.

The content may include document content, and the display unit may extract and display the writing information corresponding to at least one page of the document content.

The information obtainer may further include an address information obtainer that may obtain connection address information about at least one of the writing information, the content synchronization information, and the content, and the information obtainer may obtain at least one of the writing information, the content synchronization information, and the content based on the obtained connection address information.

According to an aspect of another exemplary embodiment, there is provided a device for sharing writing information, the device including a display that displays content; a writing information obtainer that obtains writing information based on a user input with respect to the displayed content; and a transmitter that transmits the writing information and content synchronization information including identification (ID) information of the content and location information of the writing information with respect to the content, and the writing information to an external device.

The content synchronization information may be information used by the external device to synchronize the writing information and the content.

The device may further include a storage that stores the content synchronization information and the writing information, wherein the display may synchronize and display the stored writing information and the content based on the stored content synchronization information.

The writing information obtainer may include an event detector that detects a writing start event and a writing finish event; and a writing information generator that generates the writing information based on the detected writing start event and the detected writing finish event.

The transmitter may further include a connection address generator that generates connection address information about at least one of the content, the content synchronization information, and the writing information.

The transmitter may transmit the generated connection address information to the external device.

The location information of the writing information may include at least one of frame information of the content, page information of the content, coordinate information of the writing information with respect to a page of the content, and coordinate information of the writing information with respect to a frame of the content.

### BRIEF DESCRIPTION OF THE DRAWINGS

These and/or other aspects will become more apparent and more readily appreciated from the following description of the exemplary embodiments, taken in conjunction with the accompanying drawings in which:

FIG. 1 is a diagram illustrating a system for sharing writing information, according to an exemplary embodiment;

FIG. 2 is a diagram illustrating a writing information layer according to an exemplary embodiment;

FIG. 3 is a flowchart of a method of sharing writing information, according to an exemplary embodiment;

FIG. 4 is a block diagram of a device for sharing writing information, according to an exemplary embodiment;

FIG. 5 is a flowchart of a method of sharing writing information, according to another exemplary embodiment;

FIG. 6 is a block diagram of a device for sharing writing information, according to another exemplary embodiment;

FIG. 7 is a flowchart of a method of synchronizing and displaying writing information, according to an exemplary embodiment;

FIG. 8 is a diagram illustrating various writing information according to an exemplary embodiment;

FIG. 9 is a diagram illustrating content synchronization information according to an exemplary embodiment;

FIG. 10 is a flowchart of a sequence of sharing writing information between a first device, a second device, a server, and a content providing server, according to an exemplary embodiment;

FIG. 11 is a diagram illustrating a screen displaying writing information, according to an exemplary embodiment;

FIG. 12 is a flowchart of a method of displaying writing information, according to an exemplary embodiment of the present invention;

FIG. 13 is a block diagram of a device for displaying writing information, according to an exemplary embodiment;

FIG. 14 is a diagram illustrating mapping of writing information and a window, according to an exemplary embodiment;

FIG. 15 is a diagram illustrating a change in writing information according to movement of a window, according to an exemplary embodiment;

FIG. 16 is a diagram illustrating a change in writing information according to a change of size of a window, according to an exemplary embodiment;

FIG. 17 is a diagram illustrating a change in writing information according to a display of a window, according to an exemplary embodiment;

FIG. 18 is a diagram illustrating a change in writing information according to deactivation of a window, according to an exemplary embodiment;

FIG. 19 is a flowchart of a method of displaying writing information, according to another exemplary embodiment;

FIG. 20 is a diagram illustrating an object in a window, according to an exemplary embodiment;

FIG. 21 is a diagram illustrating displaying writing information according to a display of an object, according to an exemplary embodiment; and

FIG. 22 is a block diagram of a device for sharing and displaying writing information, according to an exemplary embodiment.

### DETAILED DESCRIPTION

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected, and in this case, the meaning of the selected terms will be described in the detailed description. Thus, the terms used herein are defined based on the meaning of the terms together with the description throughout the specification.

In the specification, when a region is connected to another region, the regions may not only be directly connected, but may also be electrically connected via another device therebetween. Also, when a region includes an element, the region may further include another element instead of excluding the other element, otherwise differently stated. In the following description, terms such as “unit” and “module” indicate a unit for processing at least one function or operation, and they may be embodied as hardware or software or embodied by combining hardware and software.

The exemplary embodiments are described more fully with reference to the accompanying drawings. However, one or more embodiments of the exemplary embodiments may be embodied in many different forms, and should not be construed as being limited to the embodiments set forth herein; rather, these embodiments are provided so that this disclosure will be thorough and complete, and will fully convey the concept of the one or more exemplary embodiments to those of ordinary skill in the art. In the following description, well-known functions or constructions are not described in detail because they would obscure the exemplary embodiments with unnecessary detail. Also, like reference numerals in the drawings denote like or similar elements throughout the specification.

As used herein, the term “and/or” includes any and all combinations of one or more of the associated listed items. Expressions such as “at least one of,” when preceding a list of elements, modify the entire list of elements and do not modify the individual elements of the list.

Throughout the specification, writing information may denote information related to content or an object displayed on a screen of a device or other apparatus based on a user input. According to various aspects, writing information may be annotation information, but is not limited thereto. Also, for convenience of description, the writing information mentioned herein may be configured as another type of information, such as an image, a video, text, and the like.

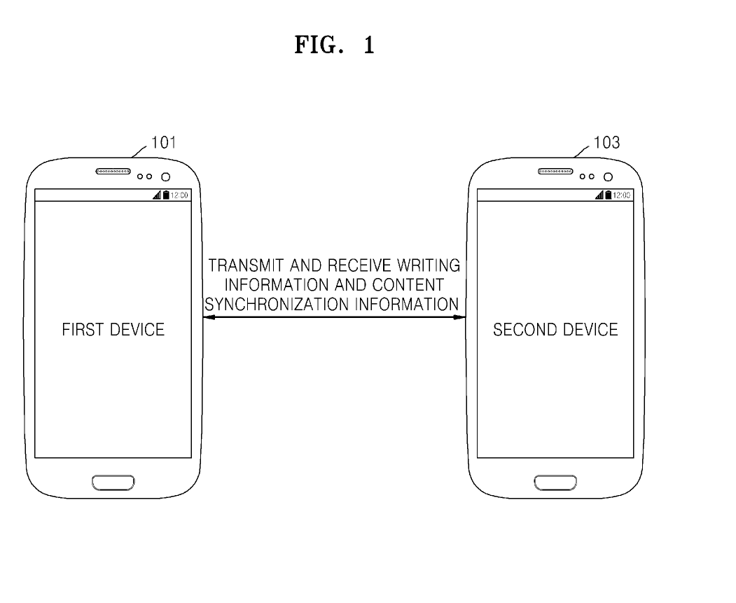

FIG. 1 is a diagram illustrating a system for sharing writing information, according to an exemplary embodiment.

Referring to FIG. 1, a first device 101 may transmit and receive writing information and content synchronization information to and from a second device 103. For example, the first and second devices 101 and 103 may share at least one of the writing information and the content synchronization information. In addition, the first and second devices 101 and 103 may share content.

According to various aspects, the writing information may include an input from the user such as a handwriting input on a touch screen by a user using a finger, a stylus, and the like. As another example, the writing information may be input by a keyboard, joystick, mouse, and the like. As another example, the writing input may include a proximity touch as well as a direct touch.

As a non-limiting example, the first and second devices 101 and 103 may be a smartphone, a smart TV, a mobile phone, a personal digital assistant (PDA), a laptop, a media player, a micro-server, a global positioning system (GPS) device, an electronic book terminal, a digital broadcasting terminal, a navigation device, a kiosk, an MP3 player, a digital camera, another mobile or non-mobile computing device, a tablet, an appliance, and the like. Also, the first and second devices 101 and 103 may include various devices for receiving a touch input, such as an electronic board or a touch table.

The first and second devices 101 and 103 may include a display unit. The display unit may include a screen of an electronic board. Examples of a device including a screen of an electronic board include a liquid crystal display (LCD) panel, a personal computer (PC), a tablet PC, a smartphone, a laptop, and the like, but are not limited thereto.

The first and second devices 101 and 103 may receive writing information from a user via an input unit. For example, the input unit may include any one of various user interfaces, such as a mouse, a keyboard, a touch pad, a track ball, an electronic pen, a touch screen, a microphone for speech recognition, an imaging device for receiving motion commands from a user, and the like. Examples of the user interface are not limited thereto.

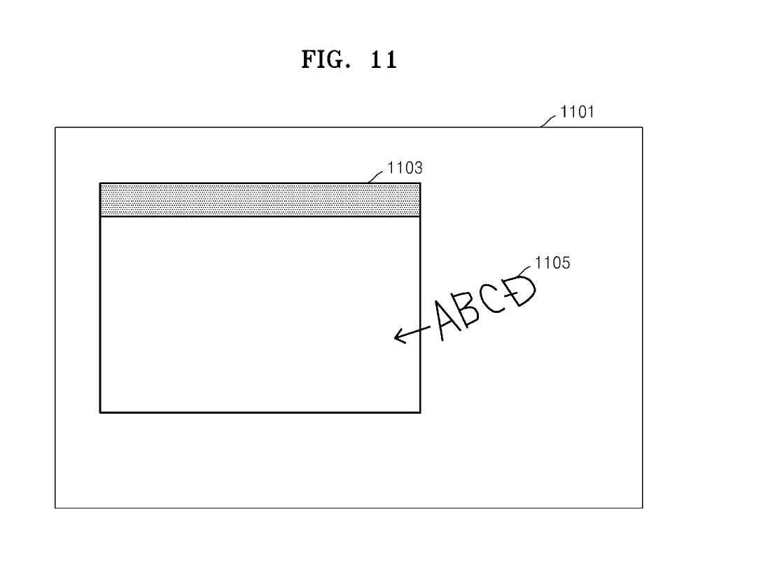

Also, the first and second devices 101 and 103 may display content on a window. According to various aspects, the first and second devices 101 and 103 may map and display the writing information and the window. Here, a window may be a unit that displays a processed result of an application or a device on a screen, as described in the examples of FIGS. 11 through 22.

According to an embodiment, the first device 101 may display content and obtain writing information about the content based on a user input. For example, the first device 101 may display the writing information about the content on the screen based on the user input and extract the writing information from the user input.

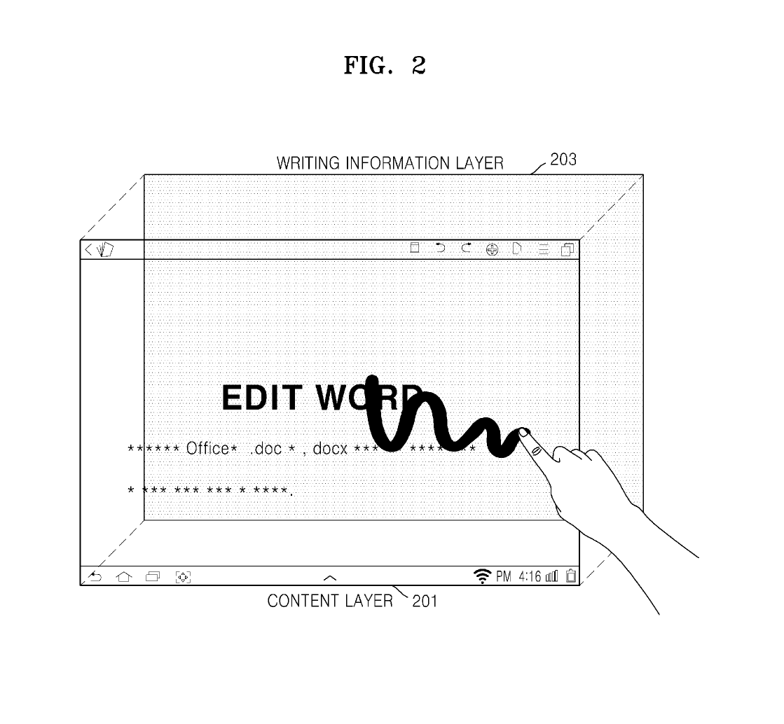

According to an embodiment, the first device 101 may display the content and the writing information together, an example of which is described with reference to FIG. 2. Also, the first device 101 may generate the content synchronization information used to synchronize the writing information and the content. Herein, the synchronization of content may denote a synchronization of writing information and content.

For example, a device may obtain writing information about first content based on a user input. Then, the device may display the obtained writing information about the first content together with second content that has the same identification (ID) information as the first content. The device may display the writing information at a location of the second content, which corresponds to a location at which the writing information about the first content is input.

For example, in the synchronization of content, when the first device 101 obtains writing information about a third page of a first document of content, the first or second device 101 or 103 may display writing information in the same format as writing information included in a third page of a second document of content that has the same ID information as the first document of content.

According to an embodiment, content synchronization information may include at least one of ID information of content and location information of writing information. The ID information may identify content that is related to content synchronization information and may include, for example, file information of the content, information about a size of the content, information about the number of pages of the content, information about the number of frames of the content, and the like.

Also, according to an embodiment, location information of the writing information may identify a location of writing information in content and may include, for example, page information of the content, frame information of the content, a location of the writing information in a page of the content, a location of the writing information in a frame of the content, and the like, and any other information capable of displaying the location of the writing information in the content. For example, the location information of the writing information may include information indicating which portion of the content the writing information is displayed while synchronizing the writing information and the content.

Furthermore, the writing information may include the location information of the writing information.

The first device 101 may transmit at least one of the writing information, the content synchronization information, and the content, to the second device 103. As another example, the first device 101 may generate connection address information about at least one of the writing information, the content synchronization information, and the content, and may transmit the generated connection address information to the second device 103.

As another example, one or more of the first and second devices 101 and 103 may be a server. For example, one or more of the first and second devices 101 and 103 may be content servers.

The second device 103 may receive a request to display content from a user, and may determine the presence of writing information and content synchronization information regarding the content that is requested to be displayed. For example, the second device 103 may display the content based on a user input, determine whether the content synchronization information and the writing information about the content displayed on a screen of the second device 103 is present, and synchronize and display the writing information and the content based on the content synchronization information.

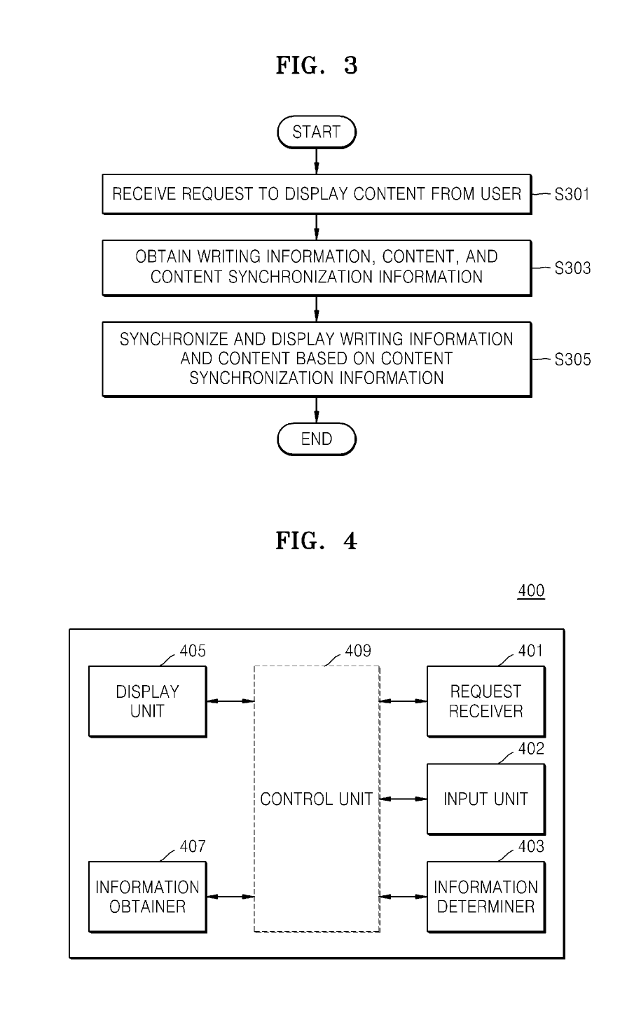

In addition, the second device 103 may obtain the content synchronization information, the content, and the writing information based on at least one of the content synchronization information, the content, and the writing information, examples of which are described with reference to FIGS. 3 through 6. As another example, the second device 103 may obtain the content, the writing information, and the content synchronization information according to the connection address information that is obtained from the first device 101, or another device or server.

Examples of the content include video content, audio content, image content, document content, and the like, but are not limited thereto.

The first and second devices 101 and 103 may extract and generate the writing information based on a user input via any of various methods. For example, the first and second devices 101 and 103 may detect a writing start event and a writing finish event to generate and extract the writing information. As another example, the first and second devices 101 and 103 may display a note about content on a screen according to a user input and extract information about the note displayed on the screen, thereby extracting and generating writing information.

An event may refer to an operation of a device which occurs according to a user input. As an example, a writing event may include a writing start event, a writing finish event, a writing movement event, a writing duration, whether the writing was a continuous touch, a proximity touch, and the like.

The obtaining of content or information refers to content or information that may be obtained by receiving the content or the information from a server or another device or by reading the content or the information from a memory stored in a device.

FIG. 2 is a diagram illustrating a method of displaying writing information, according to an exemplary embodiment. In this example, writing information is displayed on a screen of a device such as the first or second device 101 or 103 shown in FIG. 1.

Referring to FIG. 2, writing information may be displayed on a writing information layer 203 based on a user input. Also, the device may display content on a content layer 201 according to a user request. The device may overlap the writing information layer 203 and the content layer 201 to display the content and the writing information.

Referring to FIG. 2, an image displayed on a screen of the device may include at least one layer. The content is displayed on the content layer 201 that displays content, the writing information is displayed on the writing information layer 203, and the device may overlap the content layer 201 and the writing information layer 203 to display the writing information and the content together. Also, it is possible to render and display the image on the screen at the same time. It should also be appreciated that a method of displaying content on the screen of the device is not limited thereto.

For example, content and writing information may be respectively displayed on layers, and the device may overlap and display the layers on a screen. Accordingly, the device may separately store only the writing information or store a screen in which the layers are overlapped as a method of storing the writing information and the content together.

Also, the device may display writing information and content respectively on layers, based on content synchronization information, and may overlap the layers to provide a screen that displays a result of synchronizing the writing information and the content to a user.

In addition, video content may be displayed after synchronizing content and writing information, according to frames. As another example, document content may be displayed after synchronizing content and writing information, according to pages.

FIG. 3 is a flowchart of a method of sharing writing information, according to an exemplary embodiment.

Referring to FIG. 3, in operation S301, a device receives a request to display content from a user. For example, the device may select one or more contents based on a user input, and display the selected one or more contents on a screen. In addition, the device may receive a request to display writing information about content and content synchronization information from the user, before receiving the request to display content.

In operation S303, the device obtains content, writing information, and content synchronization information. For example, the content, the writing information, and the content synchronization information may be received from an external device, such as a server, or they may be obtained from a storage device or a memory of the device, and the like.

For example, the device may receive content from another device, such as a server, based on a user input, and may determine whether writing information about the received content and content synchronization information exist. If the writing information and the content synchronization information do exist but they are not stored in the device, the device may obtain the writing information and the content synchronization information from another device.

The device may receive information about whether the writing information and the content synchronization information exist while receiving the content from an external device, such as a server. For example, a content server or other type of server may store the information about whether the writing information and the content synchronization information related to the content exist and provide such information to the device. As another example, the information about whether the writing information and the content synchronization information exist may be included in metadata of the content.

Various types of metadata, such as metadata of the content, metadata of the writing information, and/or metadata of the content synchronization information, may include information about displaying whether the writing information about the content synchronization information exists. The metadata may also include connection address information that provides a connection to the writing information, the content, and the content synchronization information. The writing information and the content synchronization information may be stored and generated in a format of a metadata file such as one metadata file, separate metadata files, and the like. Also, the device may obtain at least one of the writing information, the content, and the content synchronization information.

When the device stores at least one of the writing information and the content synchronization information, the remaining of at least one of the writing information, the content synchronization information, and the content, may be obtained based on the at least one of the writing information and the content synchronization information.

If the device obtains at least one of the content synchronization information, the content, and the writing information, the device may determine the existence of other information or content and obtain the other information or the content from an external device. When the content synchronization information, the writing information, and the content are all stored in the device, the device may obtain the content synchronization information, the writing information, and the content from a storage thereof.

As another example, the device may obtain connection address information about at least one of the content, the content synchronization information, and the writing information. Accordingly, the device may obtain at least one of the content, the content synchronization information, and the writing information based on the obtained connection address information. For example, the device may obtain the content from an external device that has an address that corresponds to the connection address.

The connection address information may be included in one or more of the content, the content synchronization information, and the writing information. For example, not only the information about whether the content synchronization information and the writing information exist, but also the connection address information for connecting to the content synchronization information and the writing information may be included in the content.

As described herein, the connection address information may include a uniform resource locator (URL) or other address. Also, the connection address information may be stored in metadata of the content, the content synchronization information, and the writing information. As another example, the device may obtain the connection address information from an external device, such as a server or another device, or from the storage of the device.

In operation S305, the device synchronizes and displays the writing information and the content based on the content synchronization information. For example, the device may display the writing information on a predetermined portion of the content based on location information of the writing information included in the content synchronization information.

The content synchronization information may include at least one of ID information of the content and location information of the writing information. For example, the ID information of the content may include file information of the content, information about a size of the content, information about the number of pages of the content, information about the number of frames of the content, and the like.

The location information of the writing information may include, for example, page information of the content, frame information of the content, a location of the writing information in a page of the content, and a location of the writing information in a frame of the content, or any other information for displaying a location of the writing information. In other words, the location information of the writing information may include information about which portion of the content the writing information is displayed while the writing information and the content are synchronized.

The writing information may include, for example, event information about a writing start event and a writing finish event, text information, and the like. A user may input the writing information about the content. In response, the device may detect the writing start event and the writing finish event, and the writing information may include a location of where the writing information is received, a type of the writing information, and a size such as an area or height of the writing information.

For example, the device may receive a note about the content via an interface, such as through an electronic pen or a mouse, from the user. In this example, the user pressing of a button of the mouse or pressing of the electronic pen may be the writing start event, and unpressing of the button of the mouse or lifting of the electronic pen may be the writing finish event. A writing movement event may include a period from when the button of the mouse is pressed or the electronic pen is pressed until the button of the mouse is unpressed or the electronic pen is lifted, but is not limited thereto.

The device may detect an event generated by a user input to detect the shape and form of the writing information and generate the writing information according thereto. Also, the writing information may include text information in a bitmap form.

Examples of the content may include video content and document content, but are not limited thereto. The device may extract and display the writing information corresponding to each frame of video content from the content synchronization information, and synchronize and display the writing information and the content.

Another example of content is document content that may include not only content including various documents, but also content displayed in a still image, and the like. The document content may include a plurality of pages, and the device may extract and display the writing information corresponding to each frame of the document content from the content synchronization information, and synchronize and display the writing information and the content.

FIG. 4 is a block diagram of a device 400 for sharing writing information, according to an exemplary embodiment.

Referring to FIG. 4, the device 400 includes a request receiver 401, an input unit 402, an information determiner 403, a display unit 405, an information obtainer 407, and a control unit 409 which is also referred to as a controller 409.

The request receiver 401 may receive a request to display content from a user. For example, the device 400 may receive the request to display the content from the user through the request receiver 401. The request receiver 401 may also receive a request to select content from the user. The request receiver 401 may receive a request of the user to select writing information or content synchronization information, as well as the request to display the content.

The input unit 402 may be used by a user to input data to control the device 400 and write information on a display of the device 400. For example, the input unit 402 may include a key pad, a dome switch, a touch pad, a jog wheel, a jog switch, and the like. For example, the touch pad may include a touch capacitive type touch pad, a pressure resistive type touch pad, an infrared beam sensing type touch pad, a surface acoustic wave type touch pad, an integral strain gauge type touch pad, a piezo effect type touch pad, and the like. The input unit 402 may also include a speech recognition module, a camera to receive motion inputs by a user, and the like. The input unit 402 may receive a touch input or other type of input such as through a mouse or a keyboard, and generate writing information based on the input.

The information determiner 403 may determine whether writing information about the content and content synchronization information exist. For example, the existence of the writing information and the content synchronization information selected through the request receiver 401 may be determined.

Information about whether the writing information and the content synchronization information exist may be included in the content. For example, in response to the device 400 receiving an input by a user selecting at least one of the writing information and the content synchronization information through the input unit 402, the device 400 may determine whether at least one of the content, the writing information, and the content synchronization information exists.

The display unit 405 may synchronize and display the writing information and the content based on the content synchronization information. For example, the display unit 405 may synchronize and display the content and the writing information based on ID information of the content and location information of the writing information, which may be included in the content synchronization information.

The information obtainer 407 may obtain at least one of the writing information, the content, and the content synchronization information. For example, the information determiner 403 may determine that the writing information and the content synchronization information exist, and the information obtainer 407 may obtain the writing information and the content synchronization information. As another example, the user may select the content synchronization information or the writing information, the information obtainer 407 may obtain at least one of the content, the content synchronization information, and the writing information based on the determination by the information determiner 403.

In an example in which the writing information about the content and the content synchronization information are not stored in the device 400, the information obtainer 407 may receive the content synchronization information and the writing information from an external device, a server such as a content server, and the like.

In some examples, the information obtainer 407 may obtain a remainder of at least one of the content, the writing information, and the content synchronization information that is not previously obtained based on the obtained at least one of the content, the writing information, and the content synchronization information.

For example, the remainder may be obtained based on information that was obtained first from among the content, the content synchronization information, and the writing information, connection address information included in the content, or the ID information of the content.

In some examples, the information obtainer 407 may include an address information obtainer that obtains connection address information about at least one of the writing information, the content synchronization information, and the content. The information obtainer 407 may also obtain at least one of the writing information, the content synchronization information, and the content based on the connection address information obtained by the address information obtainer.

In various examples the content may include both video content and document content. Accordingly, the display unit 405 may extract the writing information corresponding to each frame from the content synchronization information to synchronize and display the content and the writing information, or may extract the writing information corresponding to each page from the content synchronization information to synchronize and display the content and the writing information.

The device may obtain the writing information from the user while the video content is being reproduced or while the video is temporarily stopped. Examples of a method for generating writing information about video content include a method of separating video content and storing the video content in the same form as a subtitle. As another example, writing information may be included in the center of a video frame and be managed in a separate layer, such as a multiview video coding (MVC)/scalable video coding (SVC) technique, but are not limited thereto.

Time information of the video content may be included in the content synchronization information. The device may determine a time for displaying the writing information based on the time information and display the writing information on a frame of the video content at the determined time. As another example, the video content may be received via digital multimedia broadcasting (DMB) or a streaming service.

The device 400 may further include a storage (not shown). The storage may store at least one of the content, the content synchronization information, and the writing information.

The control unit 409 may control all components included in the device 400. For example, the control unit 409 may include an operation unit, such as a central processing unit (CPU), and may be included inside any component of the device 400, but is not limited thereto.

The device 400 of FIG. 4 may be the first device 101 and/or the second device 103 of FIG. 1.

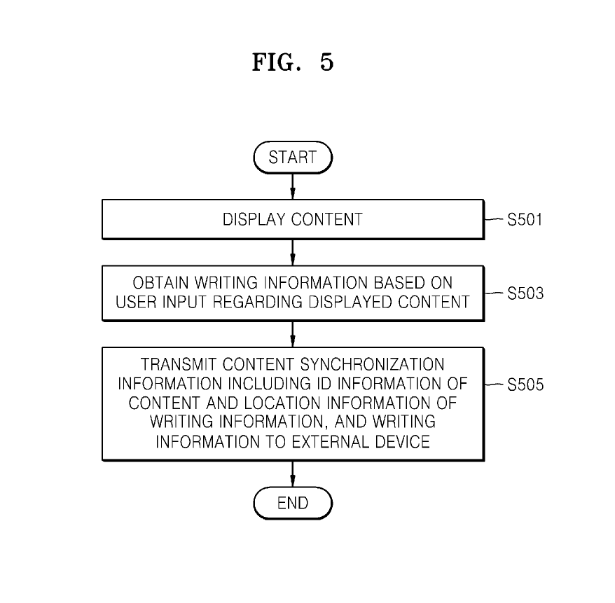

FIG. 5 is a flowchart of a method of sharing writing information, according to another exemplary embodiment.

Referring to FIG. 5, in operation S501, a device displays content. For example, the device may display the content based on a user input requesting to display the content. The content may include all objects displayable on a screen. In addition, the content may be displayed on a window in the screen.

In operation S503, the device obtains writing information based on a user input regarding the displayed content. For example, the device may obtain the writing information about the content from a user via any one of various interfaces. When the device receives an input of a user drawing a line on the screen displaying the content by using a mouse or an electronic pen, the user may generate the writing information based on a user input and obtain the writing information. As another example, the input of drawing a line may be received via a keyboard.

The device may detect a writing start event and a writing finish event and generate the writing information based on the detected writing start event and the detected writing finish event. In this example, the device may generate the writing information by detecting points of time at which the input starts and ends and a time while the input continues, as described above with reference to FIG. 3. The writing information may be displayed anywhere on the screen of the device.

According to various aspects, the device may store the writing information and may generate and store content synchronization information based on the writing information. For example, the device may store the writing information and the content synchronization information together. Also, the device may store the writing information and the content synchronization information in metadata of the writing information, metadata of the content synchronization information, and/or metadata of the content.

The device may generate and store connection address information about each of the writing information, the content, and the content synchronization information. The connection address information may include information about an address for accessing the writing information, the content, and/or the content synchronization information.

The connection address information about the writing information, the content synchronization information, and/or the content may each be stored in the writing information, the content, and the content synchronization information. Also, the connection address information about the writing information, the content, and the content synchronization information may be included in one of the writing information, the content, and the content synchronization information.

In addition, the content synchronization information may include at least one of ID information of the content and location information of the writing information. The location information of the writing information may include page information of the content, frame information of the content, a location of the writing information in a page of the content, and a location of the writing information in a frame of the content.

In operation S505, the device transmits the content synchronization information including the ID information of the content and the location information of the writing information, and the writing information to an external device. For example, the device may transmit the content synchronization information and the writing information to an external device, such as a server or another device. Also, the device may store the content synchronization information and the writing information in a storage. In addition, the device itself may operate as a server.

The device may generate the connection address information about at least one of the content, the content synchronization information, and the writing information and transmit the connection address information to the external device. Also, the device may transmit at least one of the content, the content synchronization information, and the writing information to the external device based on a request received from the external device. For example, the external device may be a server, the device of FIG. 3, and the like.

For example, the external device may display the writing information displayed on the device, on second content that has the same ID information as first content displayed on the device, based on the content synchronization information and the writing information received from the device. When the device transmitted the writing information and the content synchronization information to a server, the external device may obtain the writing information and the content synchronization information from the server.

In addition, the methods of FIGS. 3 and 5 may be performed by one device. For example, one device may perform a method of generating writing information and content synchronization information and a method of synchronizing and displaying writing information and content based on content synchronization information.

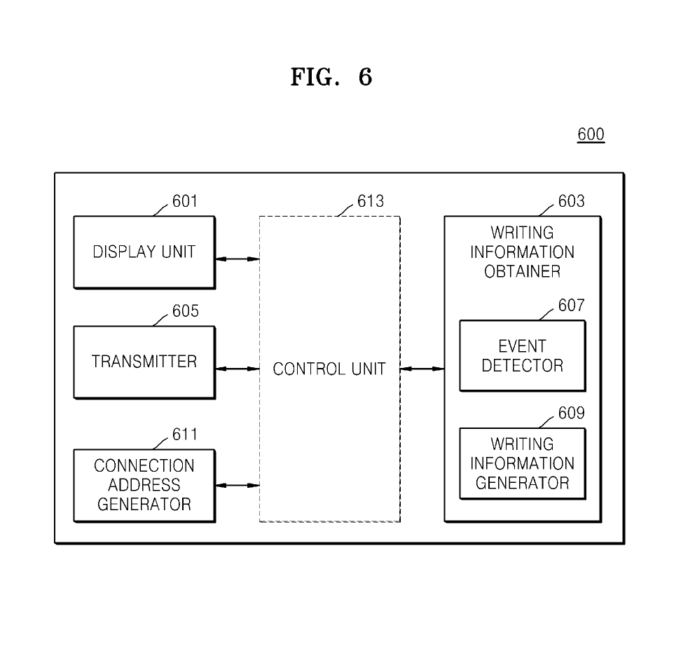

FIG. 6 is a block diagram of a device 600 for sharing writing information, according to another exemplary embodiment.

Referring to FIG. 6, the device 600 includes a display unit 601, a writing information obtainer 603, a transmitter 605, a connection address generator 611, and a control unit 613 which is also referred to as a controller 613.

The display unit 601 may display content on a screen of the device 600 based on a user input.

The writing information obtainer 603 may obtain writing information based on a user input regarding the displayed content. In this example, the writing information obtainer 603 includes an event detector 607 and a writing information generator 609.

The event detector 607 may detect a writing start event and a writing finish event. The event detector 607 may also detect a user input between the writing start event and the writing finish event, as described above with reference to FIG. 5.

The writing information generator 609 may generate the writing information based on the writing start event and the writing finish event detected by the event detector 607.

In this example, the device 600 further includes the connection address generator 611. For example, the connection address generator 611 may generate connection address information about at least one of the content, content synchronization information, and the writing information. The connection address generator 611 may transmit the generated connection address information to an external device through the transmitter 605, or may include the connection address information in at least one of the content, the content synchronization information, and the writing information.

The transmitter 605 may transmit at least one of the content, the content synchronization information, and the writing information to a server.

Also, according to an embodiment of the present invention, the device 600 may further include a storage (not shown). The storage unit may store at least one of the content, the content synchronization information, and the writing information. Also, the display 601 may synchronize and display the content and the stored writing information based on the content synchronization information stored in the storage unit.

The control unit 613 may control all components of the device 600, and may include an operation unit, such as a central processing unit, and may be included in any component, but is not limited thereto.

According to an embodiment of the present invention, the device 600 may be the device 101 or the device 103 of FIG. 1.

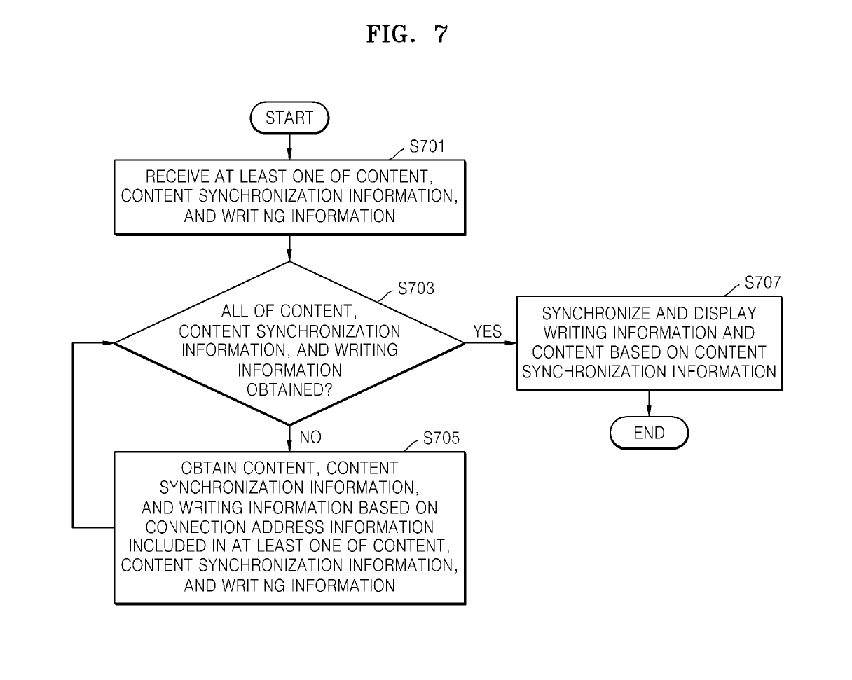

FIG. 7 is a flowchart of a method of synchronizing and displaying writing information, according to an exemplary embodiment.

Referring to FIG. 7, in operation S701, a device receives at least one of content, content synchronization information, and writing information. For example, the device may receive at least one of content, content synchronization information, and writing information from an external device according to a user's selection, or may select at least one of content, content synchronization information, and writing information stored in the device.

When the content is obtained, the device may determine whether the writing information and the content synchronization information about the content exist, and obtain the writing information and the content synchronization information based on a result of the determining. The device may obtain the writing information or the content synchronization information from an external device or a storage by identifying the content related to the writing information or the content synchronization information.

In operation S703, the device determines whether all of the content, the content synchronization information, and the writing information are obtained. If not all the information is obtained, in operation S705, the content synchronization information, and the writing information are obtained, for example, based on connection address information included in at least one of the content, the content synchronization information, and the writing information.

In response to the device obtaining not all but at least one of the content, the content synchronization information, and the writing information, the remainder may be automatically received. The device may display a confirmation window for the user to determine whether to receive information other than stored information or stored content and receive a user input.

When the device receives the content via a streaming service, the device may synchronize the writing information and each frame of the content, and display the synchronized frame. Furthermore, the device may receive the synchronized frame from another device, for example, a server such as a service provider).

Also, it may be determined whether to display the writing information while displaying the content. For example, the device may determine to display a synchronization of the content and the writing information.

In operation S707, the device synchronizes and displays the writing information and the content based on the content synchronization information. For example, the writing information may be displayed together with the content based on location information and time information of the writing information included in the content synchronization information while displaying the content on a screen of the device. As another example, the device may provide the writing information about the content to the user on a screen like the one that displayed writing information about previous content.

The device may receive an input for modifying the writing information from the user. In response, the device modifies and stores the writing information and the content synchronization information, thereby reflecting modifications of the writing information about the content. Accordingly, the writing information synchronized with the content may be modified and stored.

The device may determine a resolution and a size of the writing information based on the resolution and size of the content being reproduced. For example, the content synchronization information may include at least one of information about relative sizes and resolutions of the content and the writing information and information about the resolution of the device. Accordingly, the device may synchronize and display the content and the writing information based on the information included in the content synchronization information.

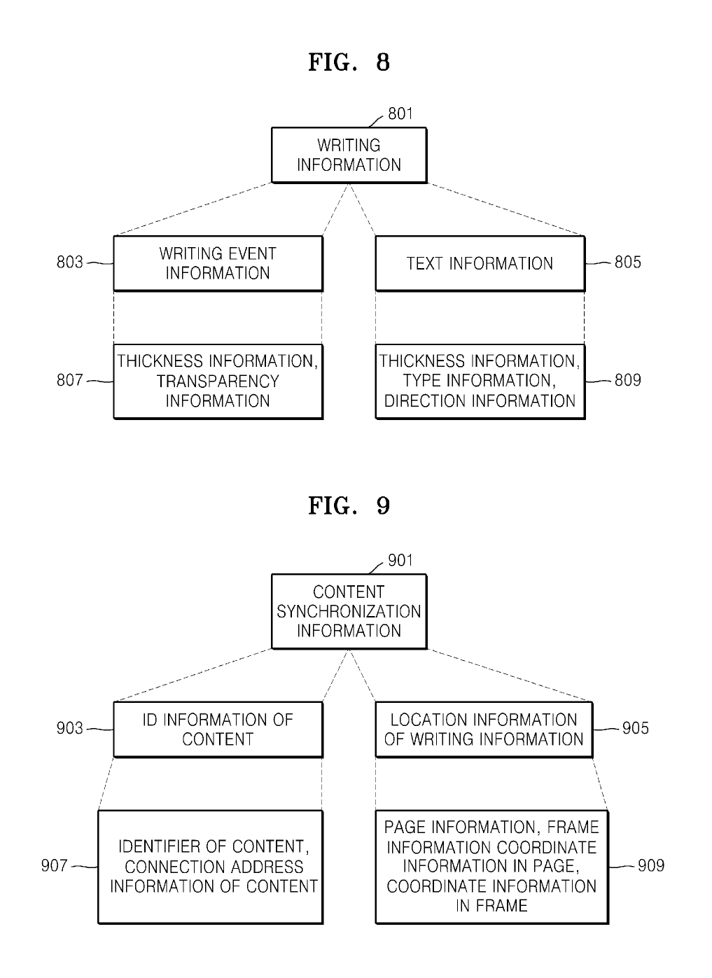

FIG. 8 is a diagram illustrating writing information 801 according to an exemplary embodiment.

The writing information 801 may include at least one of writing event information 803 and text information 805. The event refers to an operation of a device which occurs based on a user input or a signal obtained from an external device. As one example, the writing event information 803 may include a writing start event, a writing finish event, writing movement events, and the like.

The device may generate the writing start event by detecting a user input of starting to input the writing information, generate the writing movement event by tracking movement of the user, and generate the writing finish event by detecting a user input of finishing the input of the writing information.

The writing event information 803 may include information 807 for rendering the writing information and which includes, for example, coordinate information, size information, type information, thickness information, transparency information of the writing information input by the user, whether the touch was an actual touch or a proximity touch, and the like.

Also, the writing information may include the text information 805. For example, when the user inputs text using a keyboard, the writing information may be generated by extracting text information from the input text. The text information 805 may include information 809 for rendering the text, such as thickness information, type information, and direction information of the text. Also, the text information 805 may further include bitmap information of the text. Also, examples of the writing information are not limited thereto, and may include any information regarding a user input with respect to the content.

The information included in in the writing information may be classified into and stored as fields. Also, the writing information may be stored as metadata of the content and stored together with content synchronization information.

FIG. 9 is a diagram illustrating content synchronization information 901 according to an exemplary embodiment.

Referring to FIG. 9, the content synchronization information 901 may include at least one of ID information 903 of content and location information 905 of writing information.

For example, in order to identify which content the writing information input by a user is related to, a device may determine the content with respect to which the writing information is currently input and extract ID information, such as an identifier, about the content, and thereby generate the content synchronization information 901.

For example, the ID information 903 may include information 907 about at least one of an identifier, such as a file name for identifying the content, a length of the content, a size of the content, frame information of the content, page information of the content, and the like. In addition, the ID information 903 may also include connection address information of the content.

The location information 905 may include the information 909 about a location of the writing information in the content. For example, the content may be document content, and the location information 905 may include information about a coordinate and a page where the writing information is displayed.

Examples of the content synchronization information 901 are not limited thereto, and may include other information used to display the writing information that was displayed on the content at the same location of content having the same ID information.

In addition, information included in the content synchronization information 901 may be classified into and stored as fields. Also, the content synchronization information 901 may be stored as metadata of the content, or stored together with the writing information.

Also, the writing information may be stored together with the content synchronization information 901.

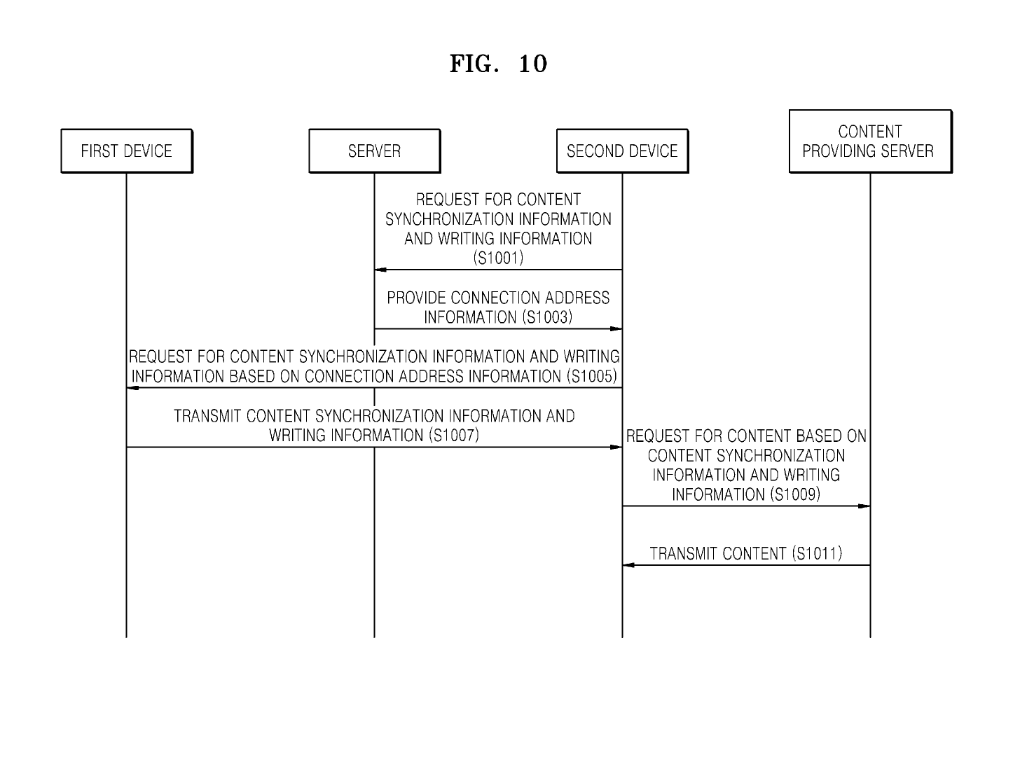

FIG. 10 is a diagram of a sequence of sharing writing information between a first device, a second device, a server, and a content providing server, according to an exemplary embodiment.

Referring to FIG. 10, in operation S1001, the second device requests the server for content synchronization information and writing information. In FIG. 10, the content synchronization information and the writing information may be stored together. As another example, the content synchronization information may be stored as metadata of content or as metadata of the writing information. Here, the second device may directly request the first device for the content synchronization information and the writing information.

In operation S1003, the server transmits connection address information about the content synchronization information and the writing information to the second device. For example, the server may store the content synchronization information and the writing information, and the server may directly provide the content synchronization information and the writing information to the second device.

In operation S1005, the second device requests the first device for the content synchronization information and the writing information based on the connection address information. In some examples, operation S1005 may be omitted if the server provided the content synchronization information and the writing information to the first device.

In operation S1007, the first device transmits the content synchronization information and the writing information to the second device. For example, the first device may provide content to the second device, as well as the content synchronization information and the writing information.

In operation S1009, the second device requests the content providing server for content based on the content synchronization information. For example, if the content is provided from the first device or is stored in a storage unit of the second device, the second device may not request the content providing server for the content.

In operation S1011, the content providing server transmits the content requested by the second device, to the second device. In some examples, the server and the content providing server may be the same server. In other words, one server may provide all of the content, the content synchronization information, and the writing information.

In FIG. 10 only the writing information is shared. As another example, the content may be received first, and then the writing information and the content synchronization information corresponding to the content may be received based on the content.

Also, if at least one of the content, the writing information, and the content synchronization information is stored in the second device, the second device may not request the first device or the server for that information that is already stored in the second device.

FIG. 11 is a diagram illustrating a screen 1101 displaying writing information 1105, according to an exemplary embodiment.

Referring to FIG. 11, the screen 1101 of a device is displaying writing information 1105, and a window 1103 corresponding to the writing information 1105.

For example, the screen 1101 of the device may be a screen of an electronic board, and the device may receive the writing information 1105 from a user via any one of various user interfaces and display the received writing information 1105 on the screen 1101. The device of FIG. 11 may be one or more of the first device 101 and the second device 103 of FIG. 1.

The window 1103 is an area where content is displayed on the screen 1101. For example, the window 1103 may be an execution window for displaying a result of executing an application such as a web browser, a Word pad, PowerPoint, and the like, or may correspond to a result processed by the device, but is not limited thereto.

Also, the device may display at least one object in the window 1103. For example, the object may include an image, text, a table, a video, and the like. The object displayed on the window 1103 may be an object indicating the entire content, or may be each object in the content. In addition, a sub-window included in the window 1103 may also be an object. The sub-window refers to an area displaying the content in the screen 1101 and may be a window displayed in the window 1103.

The device may display the window 1103 in any state. Also, the device may modify and display a display state of an object and/or content displayed in the window 1103 according to a state of the window 1103.

When the window 1103 is selected by a user and is able to receive an input of the user may refer to the window 1103 being in an activated state. A deactivated state of the window 1103 is when the window 1103 is not selected by the user and is unable to receive an input of the user. For example, an activated/deactivated window state may correspond to an activated/deactivated window state in WINDOWS® OS by MICROSOFT®, A MAC OS by APPLE®, but is not limited thereto. Also, displaying of the window 1103 is not determined according to activated and deactivated states, and the window 1103 may be displayed even in a deactivated state.

The device may display a size of the window 1103 on the screen 1101. For example, the size of the window 1103 may be adjusted based on a drag input of the user, or based on an input about size information. However, a method of adjusting the size of the window 1103 is not limited thereto.

The device may also change a location of the window 1103 on the screen 1101. For example, a user may move the window 1103 in the screen 1101 based on a user input. For example, the window 1103 may move based on a drag input of the user or based on an input about coordinate information of the user. However, a method of moving the window 1103 is not limited thereto.

The window 1103 may also be maximized on the screen 1101 of the device. The maximizing of the window 1103 may mean the window 1103 having a reduced size is displayed again on the screen 1101.

The window 1103 may also be minimized such that it is not displayed on the screen 1101. However, a minimized state of the window 1103 does not mean a state where an application executed to display the window 1103 is closed. Also, a minimized state of the window 1103 may be displayed on a status bar.

According to various aspects, the device may display the writing information 1105 on any region in the screen 1101. For example, the device may display the writing information 1105 not only on the window 1103, but also anywhere on the screen 1101.

The device may display the writing information 1105 on a writing information layer and display a window including content on a content layer. Here, the device may render and display an image to be displayed on the screen 1101 at once. An example of a method of displaying the screen 1101 of the device is not limited, as described above with reference to FIG. 2.

The device may store the writing information 1105 together with information about the window 1103. In addition, the device may generate content synchronization information used to synchronize the writing information 1105, the content displayed on the window 1103, and/or an object, and may share the writing information and the content synchronization information with another device.

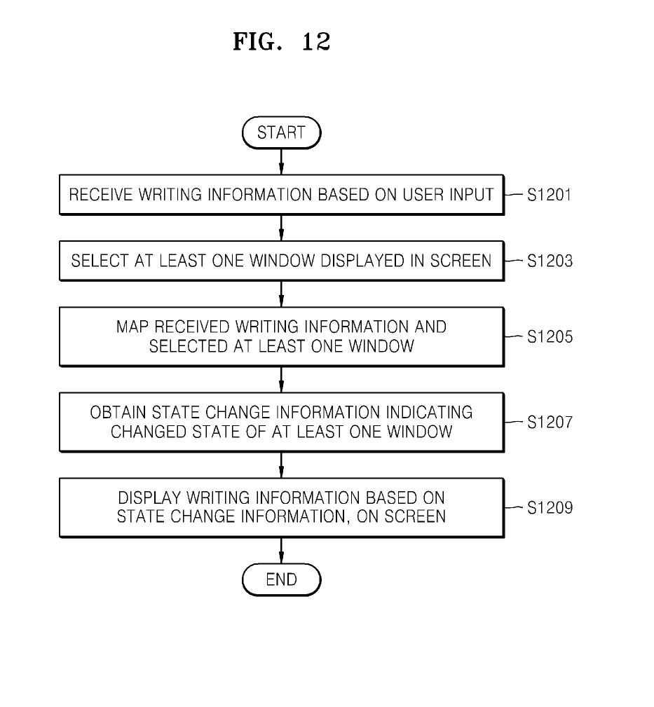

FIG. 12 is a flowchart of a method of displaying writing information, according to an exemplary embodiment.

Referring to FIG. 12, in operation S1201, a device receives writing information based on a user input. For example, the device may receive the writing information via any of various user interfaces, such as a mouse, a keyboard, a touchpad, a touch screen, an electronic pen, and the like. The device may display the writing information received based on the user input, on a screen.

In operation S1203, the device selects at least one of a plurality of windows displayed on the screen. For example, the device may select at least one of the windows that are displayed on the screen based on a user input. The device may select at least one of the windows based on the user input regardless of activated or deactivated states of the windows. As another example, the device may select an activated window from among the windows displayed on the screen.

In operation S1205, the device maps the writing information received in operation S1201 and the at least one window selected in operation S1203. For example, the mapping may map the received writing information and a selected window. In this example, the writing information received in operation S1201 and the at least one window selected in operation S1203 may be mapped and controlled together. An identifier may be assigned to each of writing information and a window, and the two identifiers may be mapped to each other so as to display that the writing information and the window should be controlled together.

The device may display a result of mapping the writing information and a selected window on a screen or on the selected window. For example, when writing information mapped to a window exists, an indicator indicating that the writing information is mapped to the window may be displayed. The device may store the writing information. Also, the device may store information about a window together with the writing information, and the information about the window may be included in metadata of the writing information. The window information may include at least one of information about an application executed to display the window, information about content, and information about an object included in the window Also, the information about mapping of a window and writing information may be included in data about the window and data about the writing information.

In operation S1207, the device obtains state change information indicating a changed state of a window. For example, the state change information may include information indicating a changed state of a window. A changed state of a window indicates a state of the window is changed and displayed by the device based on a user input. Examples of the changed state include increasing or decreasing a size of a window, moving of a window, activating or deactivating of a window, maximizing or minimizing of a window, and the like.

In operation S1209, the device displays the writing information on the screen based on the state change information. For example, the display information may include window display information indicating whether a window is displayed on a screen. Also, examples of the window display information may include information about whether a window is currently displayed and information about maximizing or minimizing of a window.

The device may determine whether to display writing information on the screen based on window display information and selectively display the writing information on the screen. Also, the device may also display writing information mapped to a window while displaying the window on the screen, and may not display the writing information mapped to the window while not displaying the window on the screen.

The state change information may include window movement information including information about a moved location of a window. That is, examples of the window movement information may include information about a previous location of a window and information about a changed location of a window. When a window is moved and displayed based on a user input, state change information may include information about a moved distance and a moved coordinate of the window. The device may also move and display writing information according to the moved window.

The state change information may also include window activation information indicating whether a window is activated. Examples of the window activation information may include information about whether an activated state of a window is changed and information about an activated state of a current window.

The device may determine whether to display writing information mapped to a window based on window activation information to selectively display the writing information.

For example, when a window is activated, the device may display writing information mapped to the window, on the screen. That is, when a window is activated, the whole window and the writing information may be displayed without being covered by a deactivated window. For example, when a window and writing information are displayed through at least one layer, the device may display an activated window and writing information mapped to the activated window on an uppermost layer.

Also, when a window is deactivated, the device may not display a part or may not display all of writing information mapped to the window. For example, when a window is deactivated, the device may not display a region overlapping an activated window or may cover the region overlapping the activated window. Thus, a region of writing information mapped to a deactivated window, which overlaps another window or other writing information, may not be displayed on the screen. Herein, not being displayed may also mean being displayed but not being able to be identified by a user by because a portion of the window is covered by another window or other writing information.

For example, state change information may include window size information indicating a size of a window such as information about a size of a window before being changed, information about a size of a window after being changed, information about an increased or decreased rate, and the like.

The device may display writing information based on window size information. For example, when a size of a window is increased or decreased, the device may increase or decrease the displayed writing information based on an increased or decreased rate of the size of the window.

The writing information may also be mapped to an object in a window. For example, state change information may include object display information indicating a display of an object on a window. In other words, examples of the object display information may include information about an object and a display of the object, for example, information about whether the object is currently or previously displayed, a coordinate of the object, a type of the object, and the like.

In some examples, a size of a window may be limited. Accordingly, all objects in the window may not be able to be displayed at once. In other words, the amount of information to be displayed may be larger than the amount of display space on the screen of the device. Thus, in order to display a large number of objects in a window, the device may use a method of displaying a window having a small size, such as a sub-window, on the window. As another example, a scroll bar may be disposed in the window so that an object displayed on the window may be moved according to a user input, and thus, a portion of the object may not be displayed and instead new information may be displayed.

The device may determine whether to display writing information mapped to an object, on the screen, based on the object display information and may selectively display the writing information.

When an entire object in a window is displayed, the device may display the entire writing information mapped to the object. As another example, when a part or all of the object is not displayed, a part or all of the corresponding writing information may not be displayed. For example, when a part or all of an object in a window is not displayed according to a scroll operation based on a user input, a part or all of writing information mapped to the object may not be displayed. Also, when a only a part of an object is displayed, a part of the corresponding writing information may be displayed based on a ratio of the part of the object that is displayed.

The writing information may be mapped to a certain coordinate in a window. Also, the device may store writing information and the writing information may include information about a mapped window, as described above with reference to FIG. 11.

The device may also store information about an object in a window mapped to writing information. For example, information about an object may include information about attributes of an object, such as a type of the object and a coordinate of the object in a window, and information about an application executed to display the window. As described herein, an object may include any one of various contents, such as a window like a sub-window, an image, text, a table, a video, and the like.

When a window including the same information as a mapped window is displayed on the screen based on writing information and information about the mapped window, the device may selectively determine whether to also display the writing information. For example, when a web browser is closed and executed again to display a web browser window on the screen, the device may determine whether writing information mapped to the web browser window is stored. Accordingly, the device may selectively determine whether to display the writing information together with the web browser window. Also, when the device obtains at least one of writing information, content synchronization information, and content, the device may obtain the remainder that has not been obtained and display the writing information, the content synchronization information, and the content together.

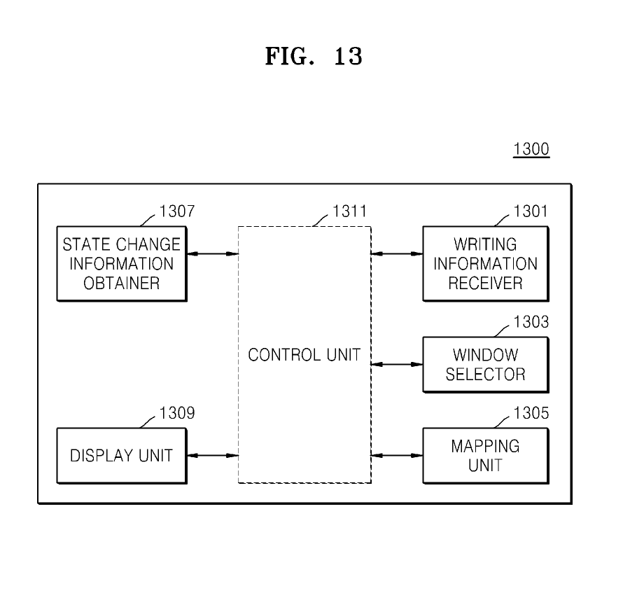

FIG. 13 is a block diagram of a device 1300 for displaying writing information, according to an exemplary embodiment.

Referring to FIG. 13, the device 1300 includes a writing information receiver 1301, a window selector 1303, a mapping unit 1305, a state change information obtainer 1307, and a display unit 1309.

The writing information receiver 1301 may receive writing information based on a user input. For example, the writing information receiver 1301 may receive writing information via any of various user interfaces, and examples of the user interface are not limited. Also, the writing information received by the writing information receiver 1301 may be displayed on the display unit 1309.

The window selector 1303 may select at least one of a plurality of windows displayed on a screen. For example, the window selector 1303 may select at least one of the windows displayed on the screen based on a user input regardless of activation or deactivation of the windows. As an example, the window selector 1303 may select an activated window from among the windows displayed on the screen.

The mapping unit 1305 may map a window selected by the window selector 1303 and writing information. For example, the mapping unit 1305 may map a window and writing information and display an indicator indicating that the mapped window and the mapped writing information exist, on the writing information or the window.

The state change information obtainer 1307 obtains state change information indicating a changed state of a window. The state change information may also include information indicating a state of a window and a changed state of a window. Examples of the changed state of the window include increasing or decreasing a size of a window, moving of a window, activating or deactivating of a window, and maximizing or minimizing of a window as described above with reference to FIG. 11.

The display unit 1309 may display writing information on the screen based on state change information. The state change information may include window display information indicating whether a window is displayed on a screen. Examples of the window display information may include information about whether a window is currently displayed and information about maximizing or minimizing of a window.

The display unit 1309 may further include a display determiner (not shown) that determines whether to display writing information on the screen based on window display information. Also, the display unit 1309 may determine whether to display writing information on the screen based on the determination of the display determiner, and selectively display the writing information on the screen.

When a window is displayed on the screen, the display unit 1309 may also display writing information mapped to the displayed window. When a window is not displayed on the screen, the display unit 1309 may not display writing information mapped to the window.

The state change information may include window movement information that includes information about a moved location of a window. Examples of the window movement information include information about a previous location of a window and information about a changed location of a window.

According to an embodiment, the display unit 1309 may display writing information mapped to a window based on window movement information. For example, when a window moves based on a user input, writing information mapped to the moved window may also be moved and displayed according to the moved window.

The state change information may include window activation information that includes information about whether a window is activated. Examples of the window activation information include information about whether an activated state of a window is changed and information about an activated state of a current window.

In some examples, the display determiner may determine whether to display writing information mapped to a window based on window activation information. Also, the display unit 1309 may selectively display writing information based on the determination of the display determiner.

When a window is activated, the display unit 1309 may display writing information mapped to the window, on the screen. For example, the whole window may be displayed without being covered by a deactivated window, and thus all writing information may be displayed on the screen such that the writing information is not covered by other writing information or another window. For example, when a window and writing information are displayed through at least one layer, the writing information may be displayed on an uppermost layer.

When a window is deactivated, the display unit 1309 may not display a part or all of writing information that is mapped to the window. For example, when a window is deactivated, the device 1300 may not display or may cover a region overlapping an activated window. Thus, a region of writing information mapped to a deactivated window, which overlaps another window or other writing information, may not be displayed on the screen. Also, the device 1300 may not display a part or all of writing information.

The state change information may include window size information indicating a size of a window. The display unit 1309 may display writing information mapped to a window based on window size information. For example, when a size of a window is increased or decreased, the device 1300 may enlarge or reduce and may display writing information based on an increased or decreased rate of the size.

The mapping unit 1305 may map writing information to an object in a window. The state change information may further include object display information indicating a display of an object on a window.

The display determiner may determine whether to display writing information mapped to an object on the screen, based on object display information. Also, the display unit 1309 may selectively display writing information based on the determination of the display determiner.

When an entire object in a window is displayed, the display unit 1309 may display all of writing information mapped to the object. As another example, when a part or all of the object is not displayed, the display unit 1309 may not display a part or all of the writing information. Also, the mapping unit 1305 may map writing information received by the writing information receiver 1301 to a certain coordinate in a window.

The device 1300 may further include a storage unit (not shown) that stores writing information. The storage unit may also store information about a window mapped to the writing information, as described above with reference to FIG. 1. The storage unit may also store information about an object in a window mapped to writing information.

The device 1300 may further include a transmitter (not shown) that transmits stored writing information to another device.

The control unit 1311 may control all components included in the device 1300, and may include an operation unit, such as a central processing unit (CPU), and may be included in another component.

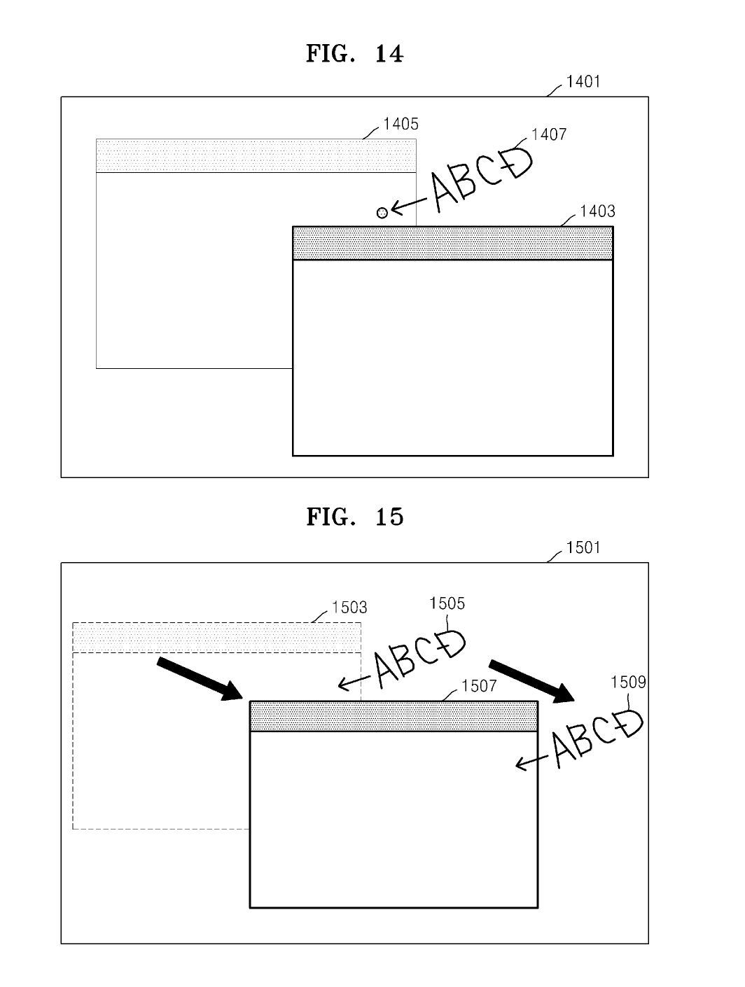

FIG. 14 is a diagram illustrating mapping of writing information and a window, according to an exemplary embodiment.

Referring to FIG. 14, windows 1403 and 1405 are displayed on a screen 1401. In this example, a device may receive writing information 1407 based on a user input and the received writing information 1407 may be displayed on the screen 1401.

The device may map the writing information 1407 and the window 1405. For example, the device may map the writing information 1407 to control the writing information 1407 together with writing information about the window 1403 or 1405.

In this example, the device may receive a user input of selecting the window 1405 in a deactivated state from a user and may map the window 1405 in the deactivated state and the writing information 1407 to each other based on a user input.

The device may map the writing information 1407 to the window 1403 or 1405 in an activated state. If the device does not receive an input of selecting a window by the user, the device may map the writing information 1407 and the window 1403 in the activated state to each other. A confirmation window for receiving a selection of the user may be displayed to induce the selection by the user. The writing information may be mapped to either of an activated window and a deactivated window.

The device may display an indicator that there is writing information mapped to the window 1403 or 1405. Also, the device may display information indicating which window the writing information is mapped to, as attribute information or metadata of the writing information.

Content synchronization information includes information for synchronizing content and writing information. Accordingly, the device may map a window where content is displayed and writing information to each other based on content synchronization information.

The writing information mapped to the window 1403 or 1405 may be controlled together with the window 1403 or 1405, as is described with reference to the examples in FIGS. 15 through 21.

FIG. 15 is a diagram illustrating a change in writing information according to movement of a window, according to an exemplary embodiment.

Referring to FIG. 15, a device may move a window in a screen 1501. For example, a location of a window in a screen may be changed and displayed according to a user input or a change of the resolution of the screen.

In the example of FIG. 15, a first window 1503 is mapped to first writing information 1505. When the first window 1503 is moved in a direction of the arrow, a second window 1507 may be displayed. Also, when the first window 1503 moves, the first writing information 1505 may also be moved and displayed together with the first window 1503, or vice versa. That is, the first window 1503 and the first writing information 1505 are a window and writing information before movement, and the second window 1507 and second writing information 1509 are the window and the writing information after movement.

The device may obtain state change information as described with reference to FIG. 11. For example, the state change information may include window movement information that includes coordinate information before movement, coordinate information after movement, a moved distance, and the like.

The device may also move and display writing information based on window movement information. For example, when a window moves according to a user input, the device may move writing information in the same distance as the window even if a separate user input is not received.

In addition, the user may also determine to move mapped writing information.

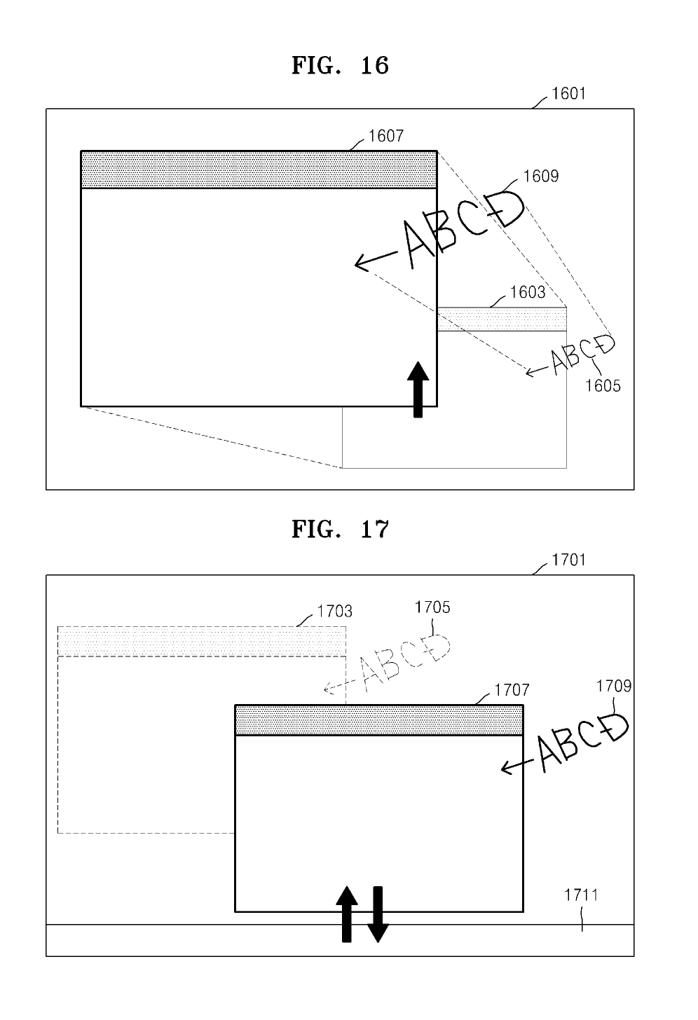

FIG. 16 is a diagram illustrating a change in writing information according to a change of size of a window, according to an exemplary embodiment.

Referring to FIG. 16, a size of a window in a screen 1601 may be changed. In this example, a first window 1603 is mapped to first writing information 1605. When a size of the first window 1603 is increased, a second window 1607 may be displayed. In response to the size of the first window 1603 being increased, a size of the first writing information 1605 may also be increased and displayed together with the first window 1603. Alternatively, a size of writing information may also be decreased when a size of a window is decreased.

According to an embodiment, a device may obtain state change information. For example, the state change information may include window size information that may include size information before a size of a window is changed, size information after a size of a window is changed, coordinate information of a window, and a changed ratio.

The device may also change and display a size of writing information based on window size information. For example, when a size of a window changes according to a user input, the device may change a size of writing information based on the size and a changed ratio of the window even if a separate user input is not received. In addition, a user may determine to change a size of mapped writing information.

FIG. 17 is a diagram illustrating a change in writing information according to a display of a window, according to an exemplary embodiment.

Referring to FIG. 17, a window may not be displayed on a screen 1701. For example, when a window is not closed but is minimized, the window may not be displayed on the screen 1701. In this example, a first window 1707 is mapped to first writing information 1709. When a size of the first window 1707 is minimized, the first window 1707 may not be displayed like a second window 1703. When the first window 1707 is not displayed, the first writing information 1709 mapped to the first window 1707 may also not be displayed.

In other words, in FIG. 17, the first window 1707 and the first writing information 1709 are a window and writing information before minimization, and the second window 1703 and second writing information 1705 shown by dashed lines represent the window and the writing information that are minimized and not displayed after minimization.

The device may obtain state change information which in this example may include window display information about whether a window is displayed on the screen 1701, information about minimizing or maximizing a window, and information about a size of a window.

The device may also determine whether to display writing information based on window display information. For example, the device may display writing information mapped to a window when the window is displayed on a screen and may not display the writing information when the window is not displayed on the screen.

As another example, the device may display writing information mapped to a window when the window is maximized and may not display the writing information when the window is minimized. Also, the device may again display the writing information when the minimized window is again displayed on the screen.

In FIG. 17, a status bar 1711 is displayed on the screen 1701. For example, when a window is minimized, a representation or an icon corresponding to the window may be displayed only on a status bar 1711 and may not be displayed on the screen 1701. Also, information about a window and a status of the window may be displayed on the status bar 1711.

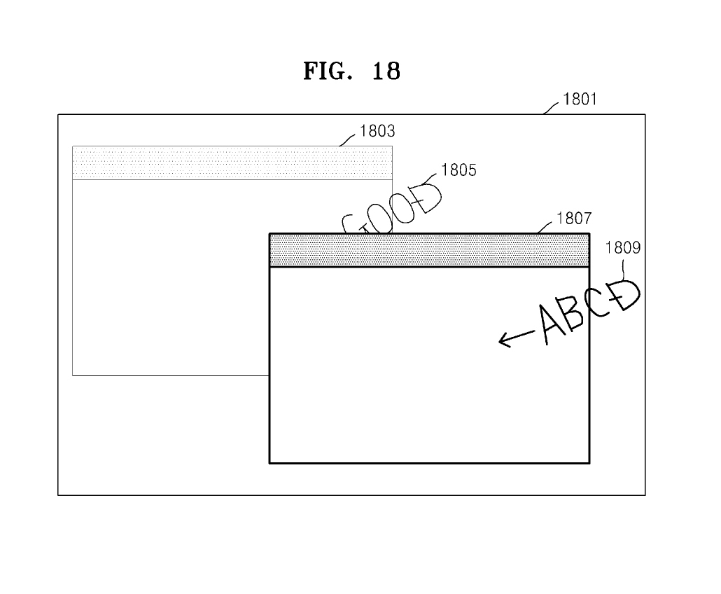

FIG. 18 is a diagram illustrating a change in writing information according to deactivation of a window, according to an exemplary embodiment.

Referring to FIG. 18, a window in a screen 1801 may be in an activated state or a deactivated state. Referring to FIG. 18, a first window 1807 is mapped to first writing information 1809, and a second window 1803 is mapped to second writing information 1805. In this example, the first window 1807 is an activated window and the second window 1803 is a deactivated window.

An activated window may be displayed on a screen without being covered by another window, an object, or writing information. In other words, the entire activated window may be displayed on a screen. Also, a deactivated window may be displayed on a screen but may be covered by an activated window, another deactivated window, an object, or writing information. In other words, a part or all of a deactivated window may not be displayed on a screen.

Referring to FIG. 18, when at least one of the first and second windows 1807 and 1803 is displayed on the screen 1801, a part or all of the second window 1803 that is a deactivated window is covered and not displayed based on the first window 1807 that is an activated window. When part or all of the second window 1803 is not displayed, part or all of the second writing information 1805 mapped to the second window 1803 may also be covered and not displayed by the first window 1807 or the first writing information 1809 mapped to the first window 1807. Alternatively, when the part or all of the second writing information 1805 is not displayed, the part or all of the second window 1803 may be covered and not displayed by the first window 1807 or the first writing information 1809.

The device may obtain state change information which in this example may include window activation information such as information about whether a window is activated, information about whether a window is overlapped by another window, and information about an overlapped size.

The device may change a size of writing information based on window activation information. For example, the device may display all writing information when a window is in an activated state, and may not display a part or all of writing information when a window is in a deactivated state. In an example in which the writing information is overlapped by an activated window or other writing information mapped to an activated window, an overlapped part of the writing information may not be displayed.

In addition, the device may apply details described above with reference to FIGS. 15 through 18 to control displaying of a window and writing information. Accordingly, when a size and a location of a window are changed together, the device may control displaying of the window and writing information using the examples described above with reference to FIGS. 15 through 18.

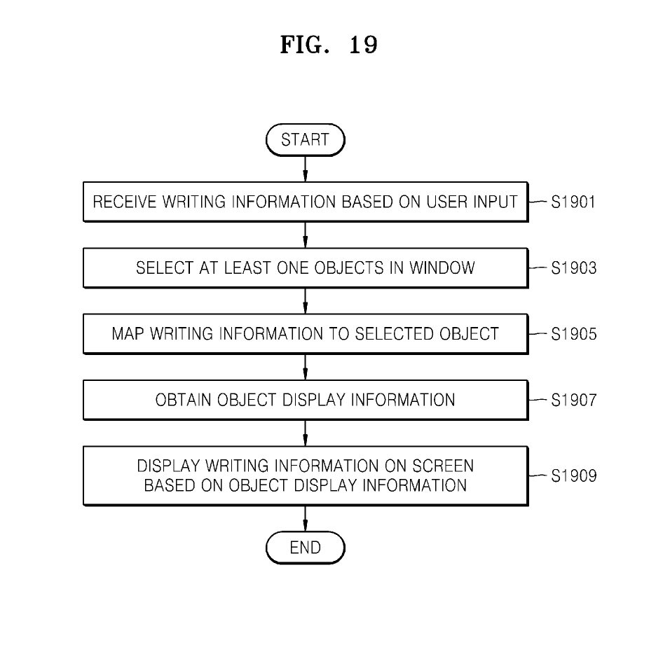

FIG. 19 is a flowchart of a method of displaying writing information, according to another exemplary embodiment.

Referring to FIG. 19, in operation S1901, a device receives writing information based on a user input. The device may display the received writing information based on a user input on a screen.

In operation S1903, the device selects at least one object in a window.

In operation S1905, the device maps writing information to the selected object. For example, the device may obtain information about objects in a window by parsing information about the window, or content or information included in the window. Also, the device may determine objects in a window based on an application for displaying the window or information about content. Examples of information about objects may include locations and types of objects.

The device may map writing information based on a type or coordinate of an object in a window, or may map sub-window writing information in a window. Information about an object may include information about content, and as described above with reference to FIGS. 1 through 10, information about an object may be included in content synchronization information.

In operation S1907, the device obtains object display information. For example, the object display information may include information about an object and a display of the object such as information about whether the object is currently or previously displayed, a coordinate location of the object, and a type of the object.

In operation S1909, the device displays the writing information based on the object display information. For example, the device may determine whether to display writing information mapped to an object based on whether the object is displayed on a window. For example, if a size of a window is limited, all of the objects included in the window may not be able to be displayed at once. Accordingly, the device may display writing information mapped to an object only when the object is displayed on a window in a screen. As described above, displaying of writing information mapped to an object may be determined based on a state of a window.

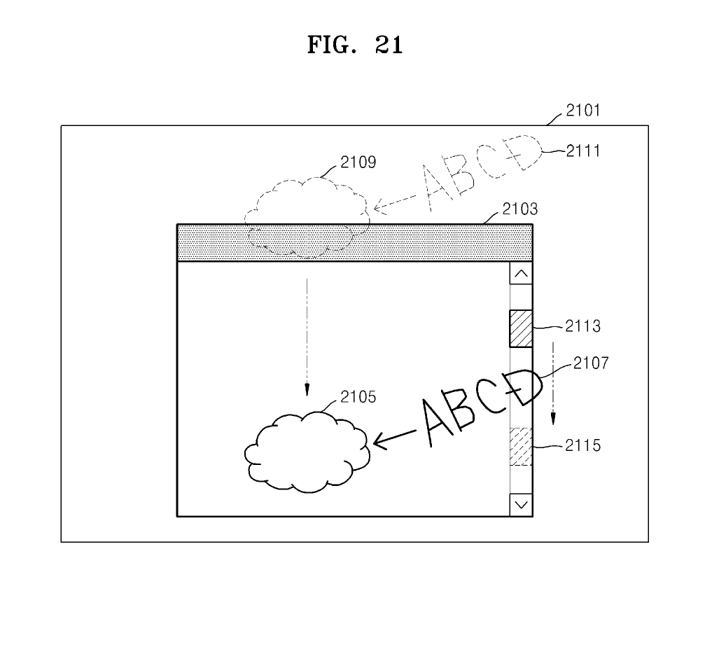

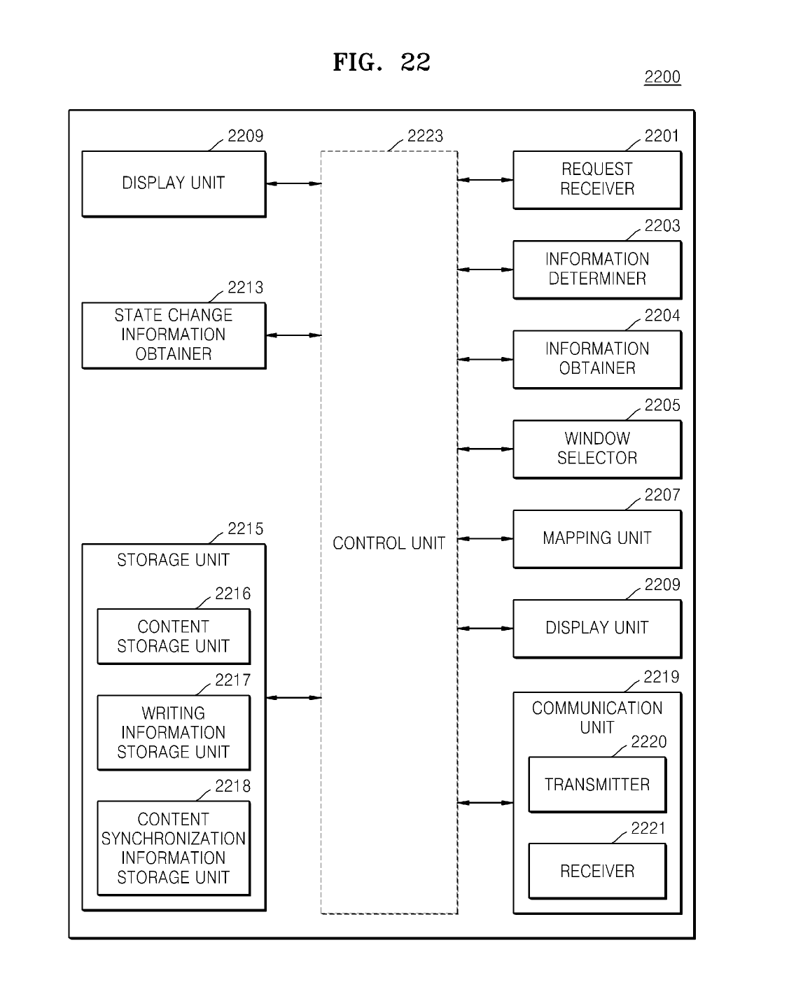

When a whole object in a window is displayed, the device may display all writing information mapped to the object, and when a part or all of an object in a window is not displayed, the device may not display a part or all of writing information mapped to the object, as is described in the example of FIG. 21.

In addition, the device may also store information about an object in a window mapped to writing information. For example, information about an object may include information about attributes of an object, such as a type of the object and a coordinate of the object in a window, and information about an application executed to display the window.

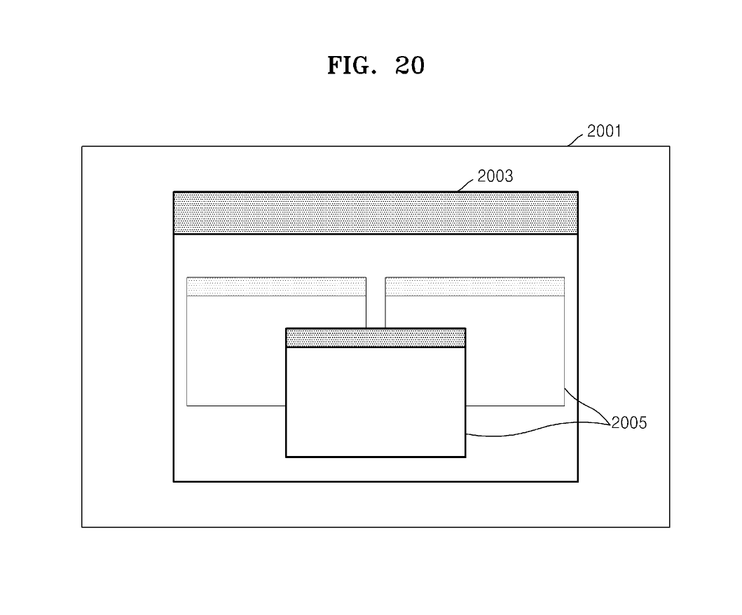

FIG. 20 is a diagram illustrating an object in a window, according to an exemplary embodiment.

Referring to FIG. 20, a window 2003 is displayed on a screen 2001. Also, sub-windows 2005 are displayed over the window 2003.

For example, the sub-windows 2005 may be examples of objects, and various objects, such as an image, text, a table, and a frame, may be displayed on the window 2003. In other words, an object may be any object included in the window 2003 and may be content. Also, the sub-window 2005 may include another sub-window.

FIG. 21 is a diagram illustrating displaying of writing information according to a display of an object, according to an exemplary embodiment.

Referring to FIG. 21, a window 2103 is displayed on a screen 2101 of a device. A first object 2105 is displayed on the window 2103. As described above with reference to FIG. 19, first writing information 2107 may be mapped to the first object 2105 in the window 2103.

The device may obtain window state change information which in this example may include object display information that may include information about a type of an object in a window, information about a coordinate of an object in a window, information about a display of an object on a window, and scroll information of a window. Also, a display of an object on a window may be determined based on a scroll bar location of the window.

Referring to FIG. 21, when a scroll bar is at a first location 2113, the first object 2105 may be displayed on the window 2103 in the screen 2101. In this example, the first object 2105 in the window 2103 is mapped to first writing information 2107. When the scroll bar moves to a second location 2115 from the first location 2113, the first object 2105 may not be displayed like a second object 2109. When the first object 2105 is not displayed, the first writing information 2107 mapped to the first object 2105 may also not be displayed like the second writing information 2111.

In FIG. 21, the first object 2105 and the first writing information 2107 are an object and writing information when the scroll bar is at the first location 2113, and the second object 2109 and the second writing information 2111 are the object and the writing information when the scroll bar is at the second location 2115. In this example, the second object 2109 and the second writing information 2111 are shown by dashed lines to indicate that they may not be actually displayed on the screen 2101.

In addition, mapping of synchronization with writing information is possible even when content is displayed in a form other than a window.

FIG. 22 is a block diagram of a device 2200 for sharing and displaying writing information, according to an exemplary embodiment.

Referring to FIG. 22, the device 2200 includes a request receiver 2201, an information determiner 2203, an information obtainer 2204, a window selector 2205, a mapping unit 2207, a display unit 2209, a state change information obtainer 2213, a storage unit 2215, a communication unit 2219, and a control unit 2223.

The request receiver 2201 may receive a request to display content from a user. The device 2200 may display content or an object on a window based on the request received by the request receiver 2201. The request receiver 2201 of FIG. 22 corresponds to the request receiver 401 of FIG. 4.

The information determiner 2203 may determine whether writing information about content and content synchronization information exist. The information determiner 2203 of FIG. 22 corresponds to the information determiner 403 of FIG. 4.

The information obtainer 2204 may obtain writing information and content synchronization information from a server or an external device when the writing information and the content synchronization information exist. As another example, the writing information may be obtained based on a user input. According to some embodiments, the information determiner 2203 may include the information obtainer 2204.

As described above with reference to FIG. 6, the information obtainer 2204 may detect a writing start event and a writing finish event of a user input, and extract and generate writing information based on the user input. The operations of the information obtainer 2204 correspond to those of the writing information obtainer 603 of FIG. 6.

The window selector 2205 may select a window displaying content and/or an object based on a user input.

The mapping unit 2207 may map writing information and a window selected by the window selector 2205. Writing information mapped to a window may be input by a user or obtained through the information determiner 2203.

As another example, the mapping unit 2207 may map writing information and a window based on content synchronization information obtained by the information determiner 2203. For example, the device 2200 may map writing information and a window, writing information and content, or writing information and an object.

The display unit 2209 may display content, an object, a window, and the like, based on a user request. Also, the display unit 2209 may display writing information based on a user input, or may synchronize and display writing information and content based on content synchronization information, as described with reference to FIGS. 4 and 6.

The state change information obtainer 2213 may obtain state change information indicating a changed state of a window. For example, the state change information obtainer 2213 may obtain information about display states of a window and an object in the window, and the display unit 2209 may change a display of writing information based on the information that is obtained by the state change information obtainer 2213, as described above with reference to FIG. 13.

In this example, the storage unit 2215 includes a content storage unit 2216, a writing information storage unit 2217, and a content synchronization information storage unit 2218.

The content storage unit 2216 may store content. Also, the writing information storage unit 2217 may store writing information received from an external device or writing information that is displayed based on a user input. The content synchronization information storage unit 2218 may store content synchronization information for writing information and content.

In this example, the communication unit 2219 includes a transmitter 2220 and a receiver 2221. The transmitter 2220 and the receiver 2221 may transmit and receive content, writing information, and content synchronization information, respectively.

The control unit 2223 may control all components included in the device 2200, and may include an operation unit such as a central control apparatus, and may be included in another component of the device 2200.

Although not shown in FIG. 22, the device 2200 may further include a connection address generator that operates as described above with reference to FIG. 6.

The device described herein may comprise a processor, a memory for storing program data and executing it, a permanent or semi-permanent storage such as a disk drive, a communications port for communicating with external devices, and user interface devices, including a display, keys, etc. When software modules are involved, these software modules may be stored as program instructions or computer-readable codes executable on the processor on a computer-readable media such as read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the present description, reference has been made to the exemplary embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present description may be described in terms of functional block components and various processing steps. Such functional blocks may be realized by any number of hardware and/or software components configured to perform the specified functions. For example, the present description may employ various integrated circuit components, e.g., memory elements, processing elements, logic elements, look-up tables, and the like, which may carry out a variety of functions under the control of one or more microprocessors or other control devices. Similarly, where the elements of the present description are implemented using software programming or software elements the description may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present description could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a”, “an”, and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the present invention.

What is claimed is:

1. A method of sharing writing information, the method comprising:
receiving a request to display content from a user;
obtaining the content, writing information about the content, and content synchronization information required to synchronize the content and the writing information; and
synchronizing and displaying the writing information and the content based on the content synchronization information.

2. The method of claim 1, further comprising determining that the writing information about the content and the content synchronization information are present.

3. The method of claim 1, wherein the obtaining comprises:
obtaining the content synchronization information; and
obtaining at least one of the writing information and the content based on the obtained content synchronization information.

4. The method of claim 1, wherein the obtaining comprises:
obtaining the content; and
obtaining at least one of the writing information and the content synchronization information based on the obtained content.

5. The method of claim 1, wherein the content synchronization information comprises at least one of identification (ID) information of the content and location information of the writing information.

6. The method of claim 5, wherein the location information of the writing information comprises at least one of page information of the content, frame information of the content, a location of the writing information with respect to a page of the content, and a location of the writing information with respect to a frame of the content.

7. The method of claim 1, wherein the writing information comprises at least one of event information about a writing start event and a writing finish event, and text information about the writing information.

8. The method of claim 1, wherein the content comprises video content, and
the synchronizing and displaying of the writing information and the content based on the content synchronization information comprises extracting and displaying writing information corresponding to at least one frame of the video content.

9. The method of claim 1, wherein the content comprises document content, and
the synchronizing and displaying of the writing information and the content based on the content synchronization information comprises extracting and displaying writing information corresponding to at least one page of the document content.

10. The method of claim 1, wherein the obtaining comprises:
obtaining connection address information about at least one of the writing information, the content synchronization information, and the content; and
obtaining at least one of the writing information, the content synchronization information, and the content, from an external device, based on the obtained connection address information.

11. A method of sharing writing information, the method comprising:
displaying content;
obtaining writing information based on a user input with respect to the displayed content; and
transmitting the writing information and content synchronization information comprising identification (ID) information of the content and location information of the writing information with respect to the content, to an external device,
wherein the content synchronization information is used by the external device to synchronize the writing information and the content.

12. The method of claim 11, further comprising:
storing the content synchronization information and the writing information; and
synchronizing and displaying the stored writing information and the content based on the stored content synchronization information.

13. The method of claim 11, wherein the obtaining of the writing information comprises:
detecting a writing start event and a writing finish event; and
generating the writing information based on the detected writing start event and the detected writing finish event.

14. The method of claim 11, wherein the transmitting comprises:
generating connection address information about at least one of the content, content information, and the writing information; and
transmitting the generated connection address information to the external device.

15. The method of claim 11, wherein the location information of the writing information comprises at least one of frame information of the content, page information of the content, coordinate information of the writing information with respect to a page of the content, and coordinate information of the writing information with respect to a frame of the content.

16. A device for sharing writing information, the device comprising:
a display request receiver configured to receive a request to display content from a user;
an information obtainer configured to obtain the content, writing information about the content, and content synchronization information; and
a display configured to synchronize and display the writing information and the content based on the content synchronization information.

17. The device of claim 16, further comprising an information determiner configured to determine that the writing information about the content and the content synchronization information are present.

18. The device of claim 16, wherein the information obtainer is configured to obtain at least one of the writing information and the content based on the obtained content synchronization information.

19. The device of claim 16, wherein the information obtainer is configured to obtain at least one of the writing information and the content synchronization information based on the obtained content.

20. The device of claim 16, wherein the content synchronization information comprises at least one of identification (ID) information of the content and location information of the writing information.

21. The device of claim 20, wherein the location information of the writing information comprises at least one of page information of the content, frame information of the content, a location of the writing information with respect to a page of the content, and a location of the writing information with respect to a frame of the content.

22. The device of claim 16, wherein the writing information comprises at least one of event information about a writing start event and a writing finish event, and text information about the writing information.

23. The device of claim 16, wherein the content comprises video content, and
the display is configured to extract and display the writing information corresponding to at least one frame of the video content.

24. The device of claim 16, wherein the content comprises document content, and
the display is configured to extract and display the writing information corresponding to at least one page of the document content.

25. The device of claim 16, wherein the information obtainer further comprises an address information obtainer that is configured to obtain connection address information about at least one of the writing information, the content synchronization information, and the content, and
the information obtainer is configured to obtain at least one of the writing information, the content synchronization information, and the content based on the obtained connection address information.

26. A device for sharing writing information, the device comprising:
a display configured to display content;
a writing information obtainer configured to obtain writing information based on a user input with respect to the displayed content; and
a transmitter configured to transmit content synchronization information comprising identification (ID) information of the content and location information of the writing information with respect to the content, to an external device,
wherein the content synchronization information is information used by the external device to synchronize the writing information and the content.

27. The device of claim 26, further comprising a storage configured to store the content synchronization information and the writing information,
wherein the display is configured to synchronize and display the stored writing information and the content based on the stored content synchronization information.

28. The device of claim 26, wherein the writing information obtainer comprises:
an event detector configured to detect a writing start event and a writing finish event; and
a writing information generator configured to generate the writing information based on the detected writing start event and the detected writing finish event.

29. The device of claim 26, wherein the transmitter further comprises a connection address generator configured to generate connection address information about at least one of the content, the content synchronization information, and the writing information, and
the transmitter is configured to transmit the generated connection address information to the external device.

30. The device of claim 26, wherein the location information of the writing information comprises at least one of frame information of the content, page information of the content, coordinate information of the writing information with respect to a page of the content, and coordinate information of the writing information with respect to a frame of the content.

31. A non-transitory computer-readable medium having recorded thereon a computer program that is executable by a computer to perform the method of claim 1.
